(19) United States
(12) Patent Application Publication
(10) Pub. No.: US 2020/0111487 A1
(43) Pub. Date: Apr. 9, 2020

(54) VOICE CAPABLE API GATEWAY

(71) Applicant: CA, Inc., New York, NY (US)

(72) Inventor: Jayanth Sanganabhatla, Osmannagar (IN)

(21) Appl. No.: 16/151,746

(22) Filed: Oct. 4, 2018

(51) Int. Cl. G10L 15/22; G10L 15/18; G10L 15/30

(52) U.S. Cl. CPC G10L 15/22; G10L 2015/223; G10L 15/30; G10L 15/1822

(57) ABSTRACT

An application programming interface gateway receives a service request containing a voice command for invoking a first service for which the API gateway processes API calls, a manifest repository including a manifest file associated with the first service and containing a mapping from text commands to API endpoints associated with the first service, and a voice command processor that receives the voice command, converts the voice command to a converted text command, compares the converted text command to entries in the manifest, selects an entry in the manifest based on the converted text command, obtains a selected API endpoint associated with the entry in the manifest, constructs an API call to the service associated with the entry in the manifest that matches the converted text command, and issues the API call to the service.

### BACKGROUND

The present disclosure relates to enterprise computing systems, and in particular to the integration of voice processing capabilities to services provided in an enterprise computing system.

Distributed computing systems, or enterprise computing systems, are increasingly being utilized to support business as well as technical applications. Typically, distributed computing systems are constructed from a collection of computing nodes that combine to provide a set of processing services to implement the distributed computing applications. Each of the computing nodes in the distributed computing system is typically a separate, independent computing device interconnected with each of the other computing nodes via a communications medium, e.g., a network.

Distributed computing systems may provide a number of different application services depending on the needs of the business, including applications that support mobile devices operated by enterprise personnel. Many of these applications are legacy applications that have been deployed for many years. Updating such applications to accommodate new technologies and/or interfaces may be difficult or expensive.

For example, some newer applications support voice command recognition, which many users have found useful, particularly for mobile applications. However, legacy applications may not support voice recognition, and it may not be economically feasible to rewrite older applications to provide voice support.

### SUMMARY

Some embodiments provide an application programming interface (API) gateway including an interface for receiving a service request from a client entity, the service request containing a voice command for invoking a first service in an enterprise computing system for which the API gateway processes API calls, a manifest repository including a plurality of manifest files, each of the manifest files being associated with a respective service in the enterprise computing system and containing a mapping from text commands to API endpoints associated with respective ones of the services in the enterprise computing system, and a voice command processor that receives the voice command, converts the voice command to a converted text command, compares the converted text command to entries in the manifest, selects an entry in the manifest based on the converted text command, obtains a selected API endpoint associated with the entry in the manifest, constructs an API call to the service associated with the entry in the manifest that matches the converted text command, and issues the API call to the service.

The API gateway may be configured to receive an API response from the service, to parse the API response to obtain a voice output text message, and to provide the voice output text message to the voice command processor. The voice command processor may be configured to convert the voice output text message to an audio speech output signal, and the API gateway may be configured to output the audio speech output signal to the client entity. In some embodiments, the API gateway may transmit the voice output text message to the client entity.

The manifest file may include a plurality of entries, each of the plurality of entries in the manifest file associating a text command with an API endpoint for a corresponding service in the enterprise computing system.

The voice command processor may be configured to compare the converted text command to a plurality of entries in the manifest and to select one of the entries in the manifest based on a similarity of the one of the entries in the manifest to the converted text command.

The voice command processor may be configured to generate a similarity metric for each of a plurality of entries in the manifest that represents a similarity of the converted text command to the respected one of the plurality of entries in the manifest, and to select one of the entries in the manifest based on the similarity metric.

The voice command processor may be configured to select one of the entries in the manifest responsive to the similarity metric being higher than a first threshold level.

The voice command processor may be configured to, responsive to the selected entry in the manifest file having a similarity metric less than a second threshold level, obtain feedback regarding correctness of the selected API endpoint, and responsive to the feedback, store the converted text command in a new manifest entry including the selected API endpoint. In other embodiments, the manifest may be changed only by the application developer.

The voice command processor may convert the voice command to the converted text command by transmitting the voice command to a natural language processing system and receives the converted text command from the natural language processing system.

The API gateway may include a cloud-based API gateway in the enterprise computing system.

The API gateway may further include a processor circuit, and a memory coupled to the processor circuit, wherein the memory includes machine readable program code that when executed causes the processor circuit to perform operations of the voice command processor of receiving the voice command, converting the voice command to the converted text command, comparing the converted text command to the entries in the manifest, selecting the entry in the manifest based on the converted text command, obtaining the selected API endpoint associated with the entry in the manifest, constructing the API call to the service associated with the entry in the manifest that matches the converted text command, and issuing the API call to the service.

Some embodiments provide a method of operating an application programming interface (API) gateway, the API gateway including an entry point for receiving an audio speech signal from a client entity, the audio speech signal containing a voice command for invoking a first service in an enterprise computing system for which the API gateway processes API calls, a manifest repository including a plurality of manifest files, each of the manifest files being associated with a respective service in the enterprise computing system and containing a mapping from text commands to API endpoints associated with respective ones of the services in the enterprise computing system, and a voice command processor. The method includes receiving the voice command, converting the voice command to a converted text command, comparing the converted text command to entries in the manifest, selecting an entry in the manifest based on the converted text command, obtaining a selected API endpoint associated with the entry in the manifest, constructing an API call to the service associated with the entry in the manifest that matches the converted text command, and issuing the API call to the service.

The method may further include receiving an API response from the service, parsing the API response to obtain a voice output text message, converting the voice output text message to an audio speech output signal, and outputting the audio speech output signal to the client entity.

The method may further include comparing the converted text command to a plurality of entries in the manifest, and selecting one of the entries in the manifest based on a similarity of the one of the entries in the manifest to the converted text command.

The method may further include generating a similarity metric for each of a plurality of entries in the manifest that represents a similarity of the converted text command to the respected one of the plurality of entries in the manifest, and selecting one of the entries in the manifest based on the similarity metric.

The method may further include selecting one of the entries in the manifest responsive to the similarity metric being higher than a first threshold level.

The method may further include responsive to the selected entry in the manifest file having a similarity metric less than a second threshold level, obtaining feedback regarding correctness of the selected API endpoint, and responsive to the feedback, storing the converted text command in a new manifest entry including the selected API endpoint.

The method may further include converting the voice command to the converted text command by transmitting the voice command to a natural language processing system and receiving the converted text command from the natural language processing system.

The API gateway may include a cloud-based API gateway in the enterprise computing system.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2A is a block diagram of an API gateway according to some embodiments of the inventive concepts.

FIGS. 2B and 2C are block diagrams that illustrate voice command processing modules according to some embodiments of the inventive concepts.

FIGS. 3A and 3B are block diagrams of an API gateway and a service API according to embodiments of the inventive concepts.

FIGS. 3C and 3D are flowcharts illustrating operations of systems/methods according to embodiments of the inventive concepts.

FIG. 4 is a block diagram illustrating aspects of an API gateway according to some embodiments of the inventive concepts.

FIGS. 5 and 6 are flowcharts illustrating operations of systems/methods in accordance with some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As noted above, legacy applications supported in an enterprise computing system may not support voice recognition, and it may be economically infeasible to rewrite older applications to provide voice support. Some embodiments provide an API gateway that can provide voice command integration across an enterprise computing system without requiring rewriting or updating of legacy applications to support voice command processing.

An application programming interface (API) gateway is a function resident in an enterprise computing system that acts as a single point of entry for a defined group of services within the enterprise computing system that are accessed through an API. API gateways may have many functions within a computing system. For example, an API gateway may provide a single point of entry for API calls to multiple services hosted within the system. The internal access points for the services remain hidden to outside entities, and may therefore be reconfigured transparently. Because the internal APIs of system services are not exposed, it may be easier to maintain security of the system. Moreover, in addition to accommodating direct API requests, API gateways can be used to invoke multiple back-end services and aggregate the results for presentation to clients.

Because API gateways provide an interface to application services, they may perform a number of functions in an enterprise computing system, including, for example, API creation, API lifecycle management, API discovery, security, authentication and authorization, threat protection (e.g., code injection), protocol transformation, routing, analytics and monitoring, and contract and service level agreement (SLA) management.

Some embodiments leverage the function of an API gateway to provide a voice command interface to enterprise application services, particularly those that were not initially designed to work with voice commands. Adding this functionality to an API gateway instead of to individual services may provide a number of potential benefits, including reducing duplicative code, reducing maintenance requirements, and increased speed of adoption of new technologies.

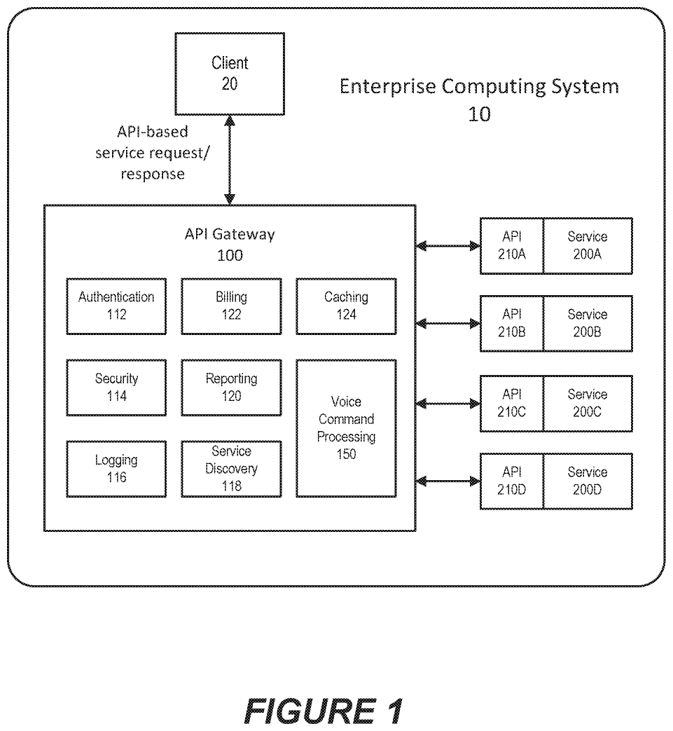

FIG. 1 is a block diagram that illustrates an API gateway 100 in an enterprise computing system 10 that offers a number of services 200A to 200D that can be accessed by clients 20 from within (or outside) the enterprise computing system 10. Each of the services 200A to 200D has an associated API 210A to 210D by which its services can be accessed. As is well known in the art, an API may include a set of rules or communication protocols by which the services of an application program may be invoked. In a distributed computing environment, a web-based API, or web API, may be defined that allows client entities to access application services. Web APIs are the defined interfaces through which interactions happen between an enterprise and applications that use its assets. A web API specifies the functional provider and exposes the service path or URL for its API users. A web API typically defines a set of specifications for requests and responses, such as Hypertext Transfer Protocol (HTTP) request messages, along with a definition of the structure of response messages, which is usually in an Extensible Markup Language (XML) or JavaScript Object Notation (JSON) format. Representational State Transfer (REST) is an architectural style that defines a set of constraints to be used for creating web services. Web services that conform to the REST architectural style, or RESTful web services, provide interoperability between computer systems on the Internet. REST-compliant web services allow the requesting systems to access and manipulate textual representations of web resources by using a uniform and predefined set of stateless operations. Other kinds of web services, such as SOAP web services, expose their own arbitrary sets of operations.

Accordingly, an application's web API may be invoked with an appropriately formed HTTP command to the web server hosting the application. A web API command is typically formed as a uniform resource locator (URL) followed by an endpoint. The command may also specify a media type and invoke standard HTTP methods, such as GET, PUT, POST, etc. An example of a web API command is “http:/example.com/get-payment-info”, where “http://example.com” is the URL that identifies the web server, and “/get-payment-info” is the endpoint that tells the web server what service is being requested.

Web API commands may be issued to the services 200A to 200D using their respective APIs. However, in many cases, it is desirable to provide an API gateway 100 that acts as a single point of entry for API calls from entities, such as the client entity 20 shown in FIG. 1. That is, when a client entity 20 desires to use a service 210, the client entity 20 does not issue an API call directly to the service 210, but rather, sends the API call to the API gateway 100, which processes the API call and determines which service should handle the request. The API gateway 100 may translate the API call and forward it to the appropriate service. As shown in FIG. 1, the API gateway 100 may include a number of modules that perform various functions, such as an authentication module 112, that authenticates API calls, a billing module 122 that handles billing for the use of services, a caching module 124 that caches API calls and responses, a security module 114, a reporting module 120, an event logging module 116 and a service discovery module 118.

In some embodiments, an API gateway 100 may also include a voice command processing module 150 that receives voice commands from the client to and processes the voice commands to responsively invoke services using API calls.

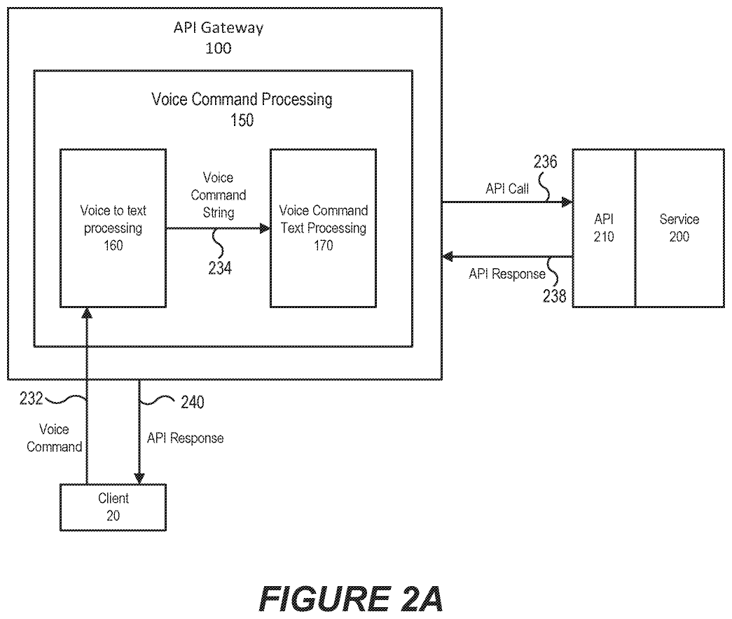

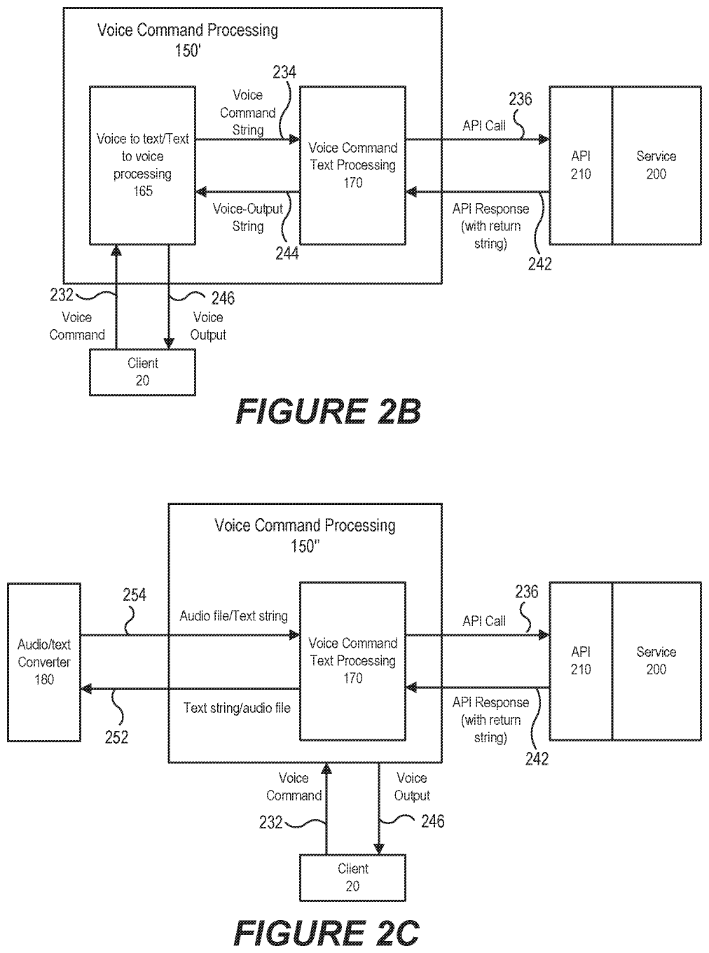

FIGS. 2A, 2B and 2C are block diagrams that illustrate voice command processing modules 150 in more detail. Referring to FIG. 2A, a voice command processing module 150 may include a voice to text (VTT) processing module 160 that converts audible speech to text and a voice command text processing module 170 that processes text commands. The VTT module 160 may employ natural language processing to convert between audio and text. Natural language processing techniques are well known in the art. The VTT processing module 160 receives a voice command 232 from a client 20 in the form of an audio signal and converts the audio signal to text. The VTT module 160 provides the converted text command string 234 to the voice command text processing module 170, which analyzes the text command and responsively generates an API call 236 as described in more detail below. The API gateway 100 then issues the API call 236 to the API 210 of the appropriate service 200. As noted above, the API gateway 100 may perform other processing on or as a result of the API call, such as protocol translation, authentication, reporting, logging, billing, etc. When the service 200 has processed the API call, the service returns an API response 238 to the API gateway 100 via the API 210, and the API gateway 100 transmits the response 240 back to the client 20.

In some embodiments, the API response includes a text string that the API gateway 100 may convert to a voice signal and provide as an audio response to the client 20. For example, referring to FIG. 2B, a voice command processing module 150′ may include a voice-to-text/text-to-voice (VTT/TTV) processing module 165 that performs conversion of both audio to text and text to audio. The VTT/TTV module 165 may employ natural language processing to convert between audio and text. The API gateway 100 is omitted from FIG. 2B for clarity.

The VTT/TTV module 165 receives a voice command 232 from a client 20 in the form of an audio signal and converts the audio signal to text. The VTT/TTV module 165 provides the converted text command string 234 to the voice command text processing module 170, which analyzes the text command and responsively generates an API call 236 as described in more detail below. The API gateway 100 then issues the API call 236 to the API 210 of the appropriate service 200. When the service 200 has processed the API call, the service returns an API response 242 to the API gateway 100 via the API 210 including a return text string (referred to as a “voice-output string”), which is provided to the VTT/TTV processing module 165 as a voice-output string 244 for conversion to an audio signal. The API gateway 100 passes the response 246 back to the client 20 including the audio response generated by the VTT/TTV module 165. An example of an API response to the API endpoint/book-a-cab including a voice-output string is shown in Table 1 below.

TABLE 1
Example API response

{
result: 1
timestamp: 1525969290
userid: 100
transactionID: 129898
voice-output: A cab has been successfully booked
}

In some embodiments, the voice-to-text/text-to-voice conversion function may be provided by an external server, that is external to the API gateway 100, such as an audio/text converter 180 shown in FIG. 2C. The audio/text converter 180 may employ natural language processing to convert between audio and text. The API gateway 100 is omitted from FIG. 2C for clarity. In the embodiment of FIG. 2C, the voice command text processing module 170 may invoke the services of an external audio/text converter 180 to convert text to voice or voice to text, for example, by issuing an API call to the audio/text converter 180. The audio/text converter 180 may be provided by an external web service provider that is external to the enterprise computing system of the API gateway 100.

Referring to FIG. 2C, a voice command processing module 150″ may invoke the services of an external audio/text converter 180 that performs conversion of both audio to text and text to audio. The API gateway 100 is omitted from FIG. 2C for clarity. The voice command text processing module 170 receives a voice command 232 from a client 20 in the form of an audio signal and transmits the voice command to the audio/text converter 180 in a request message 252. The audio/text converter 180 converts the audio signal to text and returns the text in a response message 254 to the voice command text processing module 170. The voice command text processing module 170 analyzes the text command and responsively generates an API call 236 as described in more detail below. The API gateway 100 then issues the API call to the API 210 of the appropriate service 200. When the service 200 has processed the API call, the service returns an API response 242 to the API gateway 100 via the API 210 including a voice-output string, which is provided to the audio/text converter 180 in a request message 252 for conversion to an audio signal. The audio/text converter 180 returns the converted audio signal to the voice command text processing module 170 in a response message 254. The API gateway 100 passes the response 246 back to the client 20 including the audio response.

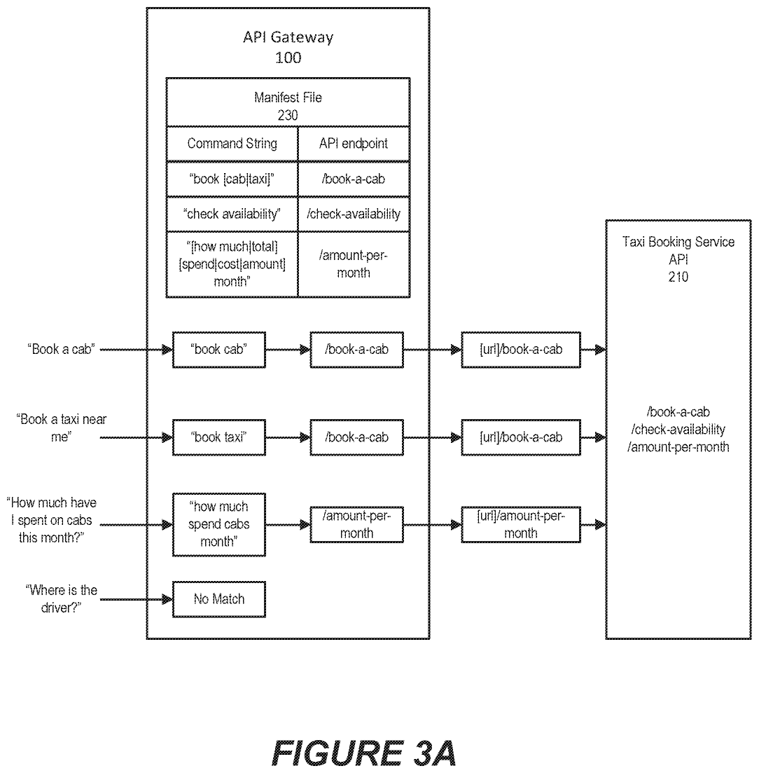

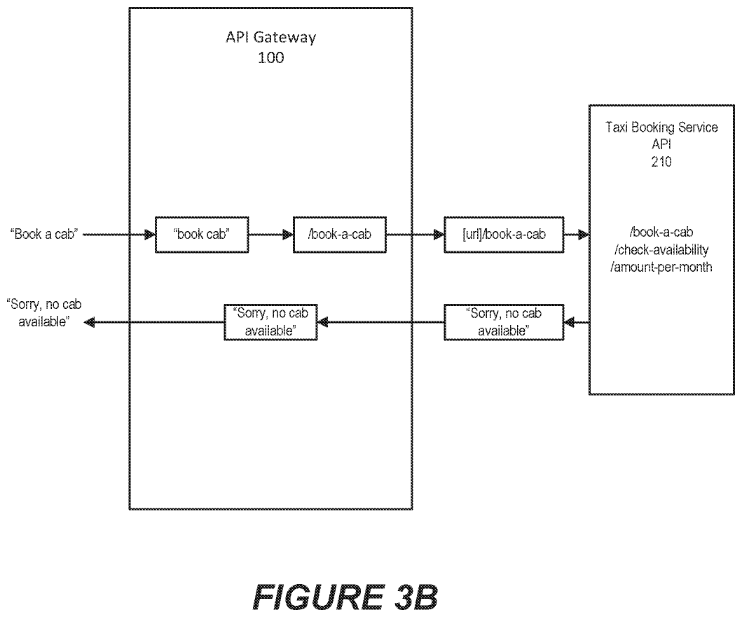

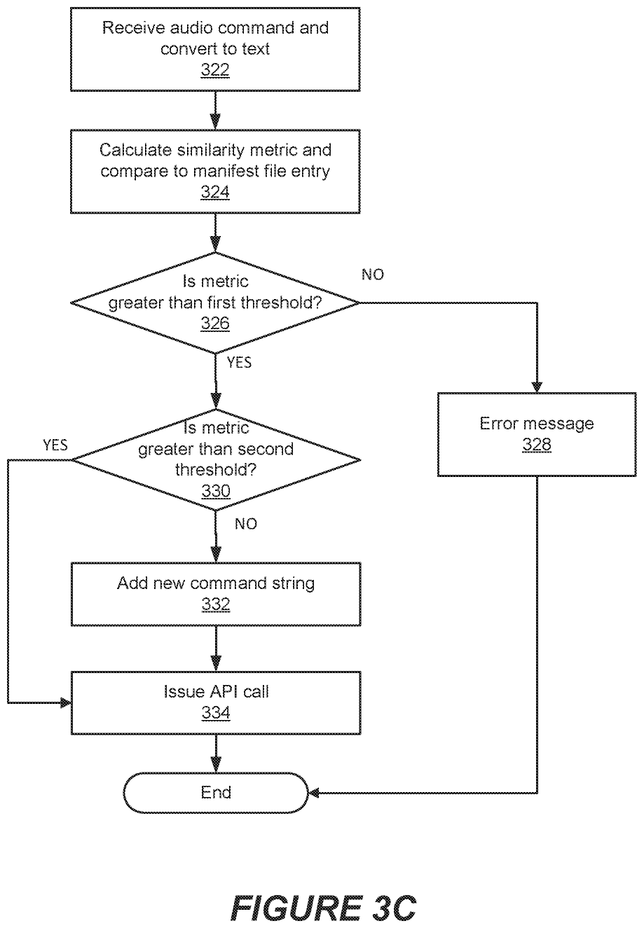

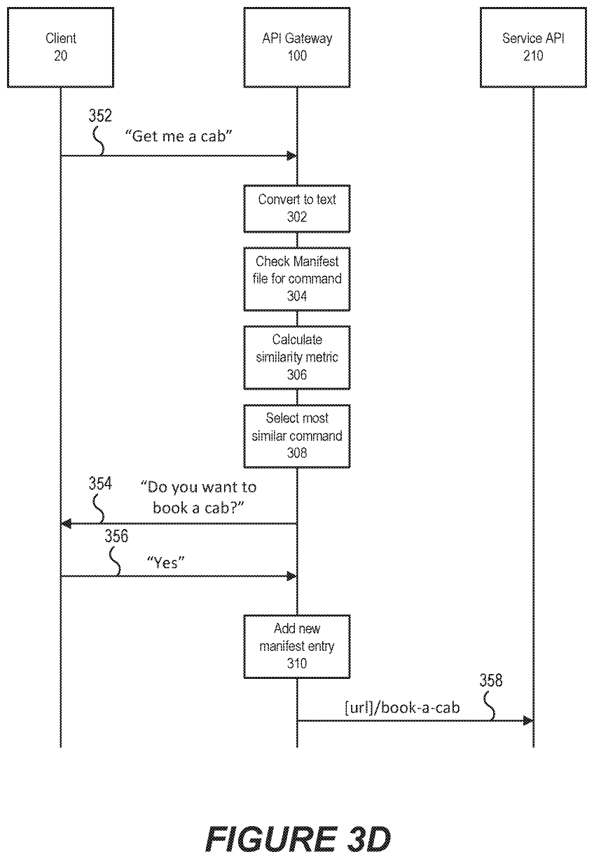

FIG. 3A is a block diagram of an API gateway 100 that illustrates the mapping of a voice command to an API endpoint and the construction of an API call in response to a voice command according to some embodiments. As shown in FIG. 3A, for each service for which an API gateway 100 according to some embodiments is configured to provide voice command capabilities, the API gateway is provided with a manifest file 230 that contains a mapping from one or more voice command strings to one or more corresponding API endpoints. The manifest file contains one or more entries. Each entry includes a command string and a corresponding API endpoint for the service associated with the manifest file 230.

In the example illustrated in FIG. 3A, the service is a taxi booking service which is accessible within the enterprise computing system via an API. The manifest file 230 includes three entries, each of which has a defined command string and associated API endpoint. The command strings may include alternative terms, and may omit “stop words” such as definite or indefinite articles, conjunctions, prepositions, pronouns, etc. For example, the command strings “book cab”, “book a cab”, “book the taxi”, and “book me a taxi” may all be interpreted as identical to the command string “book [cab|taxi]” in the first entry in the manifest file 230.

FIG. 3A illustrates the processing of four example voice commands by the API gateway 100. In a first example, a client 20 issues an API command to the taxi booking service including the voice command “book a cab.” The API command is intercepted by the API gateway 100, which converts the audio command to a text command. The text command is processed to remove stop words (e.g., articles, conjunctions, etc.), resulting in the text command “book cab.” The text command is compared to the command strings in the manifest, and a matching entry is found for “book [cab|taxi].” Because a match was found, the API gateway 100 selects the API endpoint from the corresponding entry in the manifest file (“/book-a-cab”) and constructs an API call by appending the API endpoint to an appropriate url of the taxi booking service. Other parameters may be appended to the url and endpoint to construct the API call. For example, the API call may have the form “http://taxiservice.example.com/book-a-cab?user=user1.” The API call is sent to the API 210 of the cab service, which processes the API call and provides a response to the API gateway 100 for processing and eventual forwarding to the client 20.

In a second example, a client 20 issues an API command to the taxi booking service including the voice command “book a taxi near me.” The API command is intercepted by the API gateway 100, which converts the audio command to a text command. The text command is processed to remove stop words (e.g., articles, conjunctions, etc.), again resulting in the text command “book taxi.” The text command is compared to the command strings in the manifest, and a matching entry is found for “book [cab|taxi].” Because a match was found, the API gateway 100 selects the API endpoint from the corresponding entry in the manifest file (“/book-a-cab”) and constructs an API call by appending the API endpoint to an appropriate url of the taxi booking service.

In a third example, a client 20 issues an API command to the taxi booking service including the voice command “how much have I spent on cabs this month.” The API command is intercepted by the API gateway 100, which converts the audio command to a text command. The text command is processed to remove stop words (e.g., articles, conjunctions, etc.), resulting in the text command “how much spend cabs month.” The text command is compared to the command strings in the manifest, and a matching entry is found for “how much spend month.” It will be appreciated that this is not an exact match. In some cases, the API gateway 100 may generate a metric in response to comparison of the text command and the command strings in the manifest file that quantifies a similarity between the text command and the command string in the manifest file. The metric may indicate a percentage match on a word for word basis, e.g., the percentage of words in the text command that match words in the command string, and determine that the text command matches the command string if the similarity metric exceeds a predetermined threshold and is the best match among the command strings in the manifest file. For example, the threshold may be 70%, and the API gateway 100 may determine that the text command is a 75% match to the command string. Thus, a match is found. The match may be stored in cache for future reference.

Because a match was found, the API gateway 100 selects the API endpoint from the corresponding entry in the manifest file (“/amount-per-month”) and constructs an API call by appending the API endpoint to an appropriate url of the taxi booking service.

In a third example, the text command is “where is the driver.” After preprocessing, the text command may be “where driver.” the API gateway 100 in this example is unable to find a matching entry in the manifest file, and accordingly returns an error message to the client 20. The error message may be a text message and/or an audio response (e.g., “I'm sorry, I can't find that command.”)

Referring to FIG. 3B, the API gateway 100 may receive voice output strings that can be sent to/played by the client when a response is received from the service. In the example of FIG. 3B, the client provides a voice command stating “book a cab.” After converting voice to text, the API gateway 100 compares the text command string to the manifest file (FIG. 3A), selects the corresponding API endpoint (“/book-a-cab”) and constructs an API call ([url]/book-a-cab) which it transmits to the API 210. The service processes the API call, and in this example sends an API response to the client 20 via the API gateway 100 including a voice output string “Sorry, no cab available.” The API gateway 100 converts the voice output string to a voice command (or stores the string as a voice command), and the voice command may be output to the client 20 as a voice response to the voice request.

FIG. 3C is a flowchart that illustrates operations of an API gateway 100 according to some embodiments. Referring to FIG. 3C, the API gateway 100 receives an audio command from a client 20 and converts the audio command to a text command (block 322). The API gateway 100 calculates a similarity metric of the text command to each command string in the manifest file 230 (block 324). The API gateway 100 selects the best matching entry and determines if the similarity metric for that entry is greater than a first threshold indicating a match (block 326). If not, the API gateway 100 may return an error message to the client 20 (block 328).

In some embodiments, if the similarity metric is determined at block 326 to be greater than the first threshold for an entry and therefore found to match the entry, the API gateway 100 may compare the similarity metric to a second, higher threshold at block 330, and if so add the text command as a new command string. That is, if the similarity metric indicates that the audio command is highly similar to a command string in the manifest, the API gateway 100 may modify the manifest file to add the text command as a new entry.

If the similarity metric is higher than the second threshold, the API gateway 100 may proceed to issue the corresponding API call (block 334). If, however, the similarity metric is less than the second threshold, the API gateway 100 may add the text command as a new command string (block 332) in addition to issuing the API call. For example, using the third example above and assuming the first threshold is 70% and that the client issues a voice command that is a 75% match, the API gateway 100 may determine that the text command “how much spend cabs month” matches the command string “how much spend month,” and select the appropriate API endpoint. However, because the similarity metric is less than a second threshold, e.g., 90%, the API gateway may add a new entry to the manifest file 230 containing the command string “how much spend cabs month” and associating it with the same endpoint (“amount-per-month”) (although it will be appreciated that in some embodiments, the manifest file may only be edited by a developer). In this manner, the API gateway 100 may dynamically learn new similar phrases for invoking API calls.

In other embodiments, if the similarity metric is less than a second threshold, the API gateway 100 may confirm the command before proceeding. For example, referring to the flow diagram of FIG. 3D, the client 20 may issue a voice command 352 stating “get me a cab” to the API gateway 100. The API gateway 100 converts the voice command to text (block 302) and checks the manifest file 230 for a matching command (block 304). For each command in the manifest file 230, the API gateway 100 calculates a similarity metric (block 306) and selects the entry having the highest similarity metric (block 308), which in this case is “book cab.” Assuming that the calculated similarity metric is 50%, which is less than the threshold of 70%, the API gateway 100 may confirm the selection by transmitting a voice confirmation request 354 to the client 20: “Do you want to book a cab?”. If the response 356 from the client is affirmative, the API gateway 100 may add a new entry to the manifest file for “get cab” (block 310) and issue the API request 358 corresponding to the selected command to the service API 210.

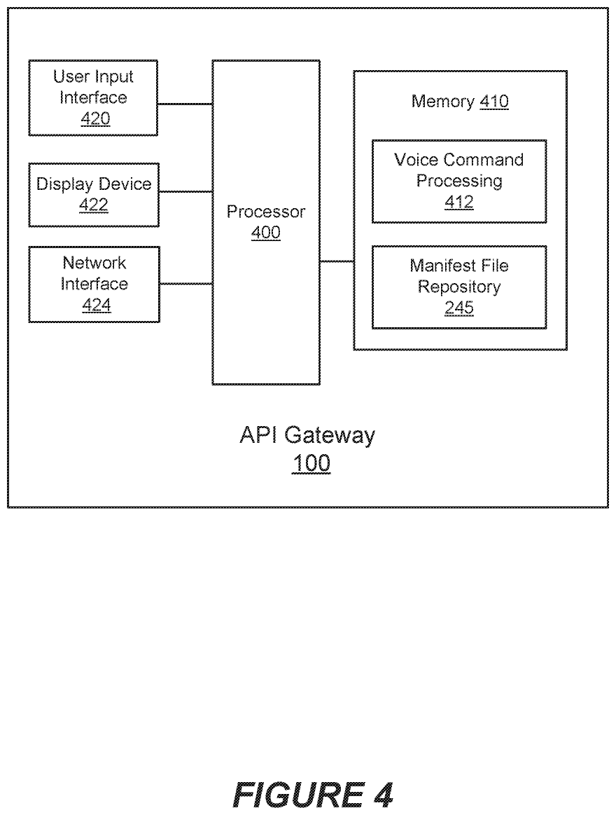

FIG. 4 is a block diagram of a device that can be configured to operate as the API gateway 100 according to some embodiments of the inventive concepts. The API gateway 100 includes a processor 400, a memory 410, and a network interface 424, which may include a radio access transceiver and/or a wired network interface (e.g., Ethernet interface).

The processor 400 may include one or more data processing circuits, such as a general purpose and/or special purpose processor (e.g., microprocessor and/or digital signal processor) that may be collocated or distributed across one or more networks. The processor 400 is configured to execute computer program code in the memory 410, described below as a non-transitory computer readable medium, to perform at least some of the operations described herein. The API gateway 100 may further include a user input interface 420 (e.g., touch screen, keyboard, keypad, etc.) and a display device 422.

The memory 410 includes computer readable code that configures the API gateway 100 to implement the voice command processing module 150. In particular, the memory 410 includes voice command processing code 412 that configures the API gateway 100 to process voice commands and a manifest file repository 245 that contains manifest files 230 for each service for which voice command processing is supported.

In particular, one capability of processor 400 may be to translate commands and responses from one language to another. For example, in some embodiments, the processor 400 may translate a non-English voice signal to an English text string, map the text string to a service as described herein, issue an API call to the service, fetch a response to the API call, translate an English string in the response to a non-English voice file, and transmit the voice file to the requesting device.

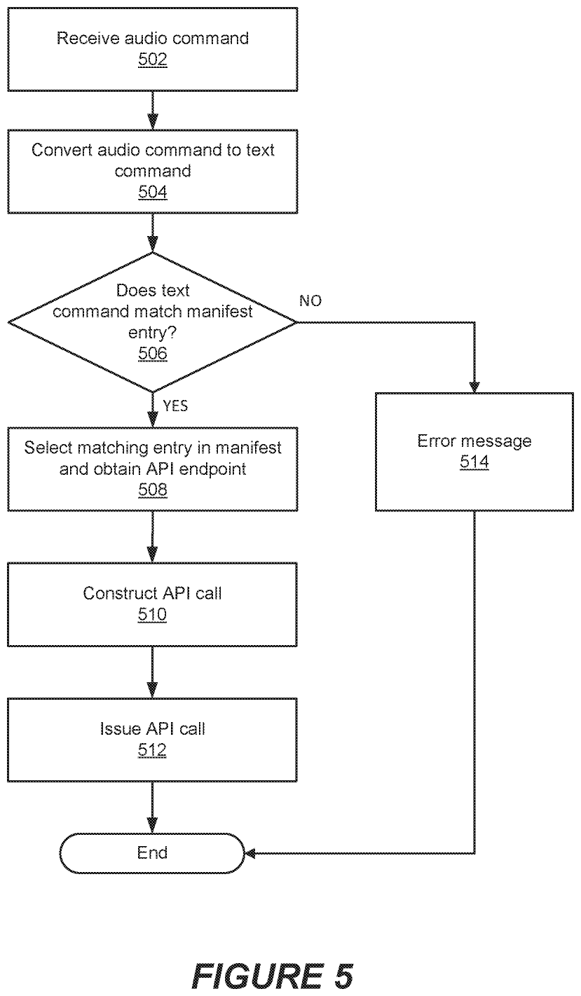

FIG. 5 is a flowchart illustrating operations of an API gateway 100 for handing a voice command according to some embodiments. Referring to FIG. 5, the API gateway 100 may receive an audio command from a client 20 (block 502) and convert the audio command to a text command (block 504). The API gateway 100 may determine if the text command matches an entry in the manifest file 230, for example, according to the methods described above (block 506), and if not, return an error message to the client 20 (block 514). If the API gateway 100 determines that the text command matches an entry in the manifest file 230, the API gateway 100 selects a matching entry in the manifest file 230 and obtains the corresponding API endpoint (block 508), constructs the API call (block 510), and issues the API call to the service (block 512).

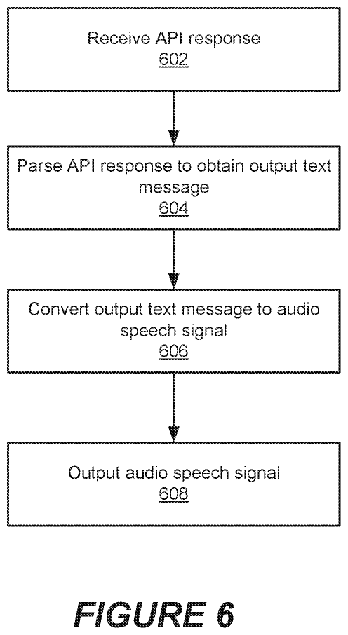

FIG. 6 is a flowchart illustrating operations of an API gateway 100 for handing a response from a service to an API request according to some embodiments. Referring to FIG. 6, the API gateway 100 may receive an API response from the service API 210 (block 602) and parse the received response to obtain an output text message (block 604). The API gateway 100 converts the response text message to an audio speech signal (block 606) and outputs the audio speech signal to the client 20 (block 608).

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. An application programming interface (API) gateway, comprising:
an interface for receiving a service request from a client entity, the service request containing a voice command for invoking a first service in an enterprise computing system for which the API gateway processes API calls;
a manifest repository comprising a plurality of manifest files, each of the manifest files being associated with a respective service in the enterprise computing system and containing a mapping from text commands to API endpoints associated with respective ones of the services in the enterprise computing system; and
a voice command processor that receives the voice command, converts the voice command to a converted text command, compares the converted text command to entries in the manifest, selects an entry in the manifest based on the converted text command, obtains a selected API endpoint associated with the entry in the manifest, constructs an API call to the service associated with the entry in the manifest that matches the converted text command, and issues the API call to the service.

2. The API gateway of claim 1, wherein the API gateway is configured to receive an API response from the service, to parse the API response to obtain a voice output text message, and to provide the voice output text message to the voice command processor;
the voice command processor is configured to convert the voice output text message to an audio speech output signal; and
the API gateway is configured to output the audio speech output signal to the client entity.

3. The API gateway of claim 1, wherein the manifest file comprises a plurality of entries, each of the plurality of entries in the manifest file associating a text command with an API endpoint for a corresponding service in the enterprise computing system.

4. The API gateway of claim 3, wherein the voice command processor is configured to compare the converted text command to a plurality of entries in the manifest and to select one of the entries in the manifest based on a similarity of the one of the entries in the manifest to the converted text command.

5. The API gateway of claim 3, wherein the voice command processor is configured to generate a similarity metric for each of a plurality of entries in the manifest that represents a similarity of the converted text command to the respected one of the plurality of entries in the manifest, and to select one of the entries in the manifest based on the similarity metric.

6. The API gateway of claim 5, wherein the voice command processor is configured to select one of the entries in the manifest responsive to the similarity metric being higher than a first threshold level.

7. The API gateway of claim 6, wherein the voice command processor is configured to:
responsive to the selected entry in the manifest file having a similarity metric less than a second threshold level, obtain feedback regarding correctness of the selected API endpoint, and responsive to the feedback, store the converted text command in a new manifest entry including the selected API endpoint.

8. The API gateway of claim 1, wherein the voice command processor converts the voice command to the converted text command by transmitting the voice command to a natural language processing system and receives the converted text command from the natural language processing system.

9. The API gateway of claim 1, wherein the API gateway comprises a cloud-based API gateway in the enterprise computing system.

10. The API gateway of claim 1, further comprising:
a processor circuit; and
a memory coupled to the processor circuit, wherein the memory includes machine readable program code that when executed causes the processor circuit to perform operations of the voice command processor of receiving the voice command, converting the voice command to the converted text command, comparing the converted text command to the entries in the manifest, selecting the entry in the manifest based on the converted text command, obtaining the selected API endpoint associated with the entry in the manifest, constructing the API call to the service associated with the entry in the manifest that matches the converted text command, and issuing the API call to the service.

11. A method of operating an application programming interface (API) gateway, the API gateway including an interface for receiving an audio speech signal from a client entity, the audio speech signal containing a voice command for invoking a first service in an enterprise computing system for which the API gateway processes API calls, a manifest repository comprising a plurality of manifest files, each of the manifest files being associated with a respective service in the enterprise computing system and containing a mapping from text commands to API endpoints associated with respective ones of the services in the enterprise computing system, and a voice command processor, the method comprising:
receiving the voice command;
converting the voice command to a converted text command;
comparing the converted text command to entries in the manifest;
selecting an entry in the manifest based on the converted text command;
obtaining a selected API endpoint associated with the entry in the manifest;
constructing an API call to the service associated with the entry in the manifest that matches the converted text command; and
issuing the API call to the service.

12. The method of claim 11, further comprising:
receiving an API response from the service;
parsing the API response to obtain a voice output text message;
converting the voice output text message to an audio speech output signal; and
outputting the audio speech output signal to the client entity.

13. The method of claim 11, wherein the manifest file comprises a plurality of entries, each of the plurality of entries in the manifest file associating a text command with an API endpoint for a corresponding service in the enterprise computing system.

14. The method of claim 13, further comprising:
comparing the converted text command to a plurality of entries in the manifest; and
selecting one of the entries in the manifest based on a similarity of the one of the entries in the manifest to the converted text command.

15. The method of claim 13, further comprising:
generating a similarity metric for each of a plurality of entries in the manifest that represents a similarity of the converted text command to the respected one of the plurality of entries in the manifest; and
selecting one of the entries in the manifest based on the similarity metric.

16. The method of claim 15, further comprising:
selecting one of the entries in the manifest responsive to the similarity metric being higher than a first threshold level.

17. The method of claim 16, further comprising:
responsive to the selected entry in the manifest file having a similarity metric less than a second threshold level, obtaining feedback regarding correctness of the selected API endpoint; and
responsive to the feedback, storing the converted text command in a new manifest entry including the selected API endpoint.

18. The method of claim 11, further comprising:
converting the voice command to the converted text command by transmitting the voice command to a natural language processing system and receiving the converted text command from the natural language processing system.

19. The method of claim 11, wherein the API gateway comprises a cloud-based API gateway in the enterprise computing system.
